(19) United States
(12) Patent Application Publication
(10) Pub. No.: US 2009/0083817 A1
(43) Pub. Date: Mar. 26, 2009

(54) Method of Operating a Communication System and Communication System for Implementing Such a Method

(76) Inventors: Gerard Nicolaas Van Den Hoven, Maria Hoop (NL); Elroy Gerard Christiaan Pluk, Prinsenbeek (NL); Douwe Harmen Geuzebroek, Enschede (NL); Edwin Jan Klein, Enschede (NL); Ronald Dekker, Amersfoort (NL)

Correspondence Address: GORDON & JACOBSON, P.C., 60 LONG RIDGE ROAD, SUITE 407, STAMFORD, CT, 06902, US

(21) Appl. No.: 12/298,081

(22) PCT Filed: Apr. 12, 2007
(86) PCT No.: PCT/EP2007/053576

§ 371 Date: Oct. 22, 2008

(30) Foreign Application Priority Data
May 4, 2006 (NL) 2000069

(51) Int. Cl. H04N 7/173

(52) U.S. Cl. 725/116

(57) ABSTRACT

A method of operating a communication system comprises a headend station and a plurality of end user stations which are connected to the headend station by means of a physical medium, and a system of one or a plurality of channels realised on this medium. There is an assignment mechanism for assigning a relevant channel to an end user station. More particularly, only a single channel is assigned to an end user station, each channel being assigned to a subset of zero, one or a plurality of end user stations. Controlled by the detection of a channel overload and/or end user dynamics, said assignment mechanism is activated to realise a new assignment of a plurality of channels while the condition is maintained that no more than a single channel is or remains assigned to each one of the end user stations.

### BACKGROUND OF THE INVENTION

1. Field of the Invention

The invention relates to a method of operating a communication system comprising a headend station and a plurality of end user stations which are connected to the headend station by means of a physical medium, and a system of one or more channels realised on this medium, which communication system comprises an assignment mechanism for assigning a relevant channel to an end user station. Such communication systems are used often, more particularly such communication systems in which each channel is realised at (in) a respective wave length (range)/frequency (range). A distinction is made between broadcasting (one channel serves all end users), unicasting (each channel serves exactly one end user), and multicasting (each channel can serve a number of end users, where the number of end users is a channel variable or channel parameter). In the following description reference is sometimes made to glass fibres and they embody a preferred version. The invention per se, however, is not restricted to glass fibre technology.

2. State of the Art

The overall capacity of such a system is tried to be used in the best possible way for the information streams desired by the end user stations. Broadcasting is not suitable or suitable to a minor extent for bidirectional transport. When unicasting is employed, the transport capacity is seldom used as well as possible. Actually, it is possible to use wavelengths or wavelength ranges by dynamic switching among a plurality of end user stations in a sharing mode, but this requires complex procedures and also complex components.

The inventor has realised that it is possible to allow each end user station at any one moment to transmit on only one channel and receive on one channel and that, as a result, simple hardware becomes a possibility. A single channel from a plurality of available channels can then be assigned each time to an exclusive subset of one or more end user stations. In this way the available bandwidth can be distributed better or in optimum fashion among the set of channels. It will be evident that then the respective channels have to have sufficient capacity to always serve the individually assigned end user stations in adequate manner, though this need not mean that each channel has to be able to serve each individual end user station.

### SUMMARY OF THE INVENTION

Consequently, it is an object of the present invention for example to provide a stable and easy-to-operate method in the environment of such a communication system.

Therefore, in accordance with one of the aspects of the method the invention is characterized by that which is recited in the characterizing part of claim 1. As such the specific assignment of the channels can be organized in a great variety of ways. Channel overload can be detected as such, for example, if there is only a certain reserve percentage of the channel capacity left. Other situations of end user dynamics occur if it is known beforehand that the required capacity varies over time, for example in the way that business clients need bandwidth especially during the day, whereas private clients watch television especially in the evening. Further reasons for changing the assignment distribution may be that it is undesired to have certain clients or certain categories of messages together on one channel, for example for security reasons, or that certain assignment distributions are “handier” for reasons of various technological considerations. For example, a first channel may have a capacity of 1 GB/s and a second channel a capacity of GB/s. The second channel can then be used, for example, for “busy” clients. Thus in this case the dynamics are that the qualitative demands placed on the end users together operating on a certain channel are or will no longer be satisfied. Generally speaking, the system and method in accordance with the invention whenever needed allow to determine a new end user assignment under the influence of user dynamics. The assignment mechanism will generally be activated only from time to time; and after a new assignment has been effected, this one will then be stationary for the time being.

The invention also relates to a communication system as claimed in claim 2, which is suitable for implementing the method as claimed in claim 1.

Forward communication and return communication may be effected on separate physical media or on a single physical medium. In this way costs can be balanced against flexibility. Said headend station preferably comprises a transmitting substation and a receiving substation which are connected to said physical medium by means of a mechanism working as a circulator so that bidirectional traffic with the end user stations can be maintained. This is a flexible implementation.

The physical medium preferably comprises one or more nodes, with at least one node being connected in parallel to a plurality of end user stations and each end user station being connected to one node. A node preferably comprises tunable filters, so that for each end user the forward channel (from headend station to end user) and the return channel (from end user to headend station) can be set by tuning the filters. In this simple manner a large number of end user stations can be “served”. A physical property of said filter is its free spectral range (FSR), defined as the difference in wavelength between two successive peaks in the low-pass filter characteristic.

The channels in a direction towards said headend station are preferably modulated on respective carrier waves supplied by the headend station, and all channels operating in a first direction are separated at least by an integer number of FSRs from all the channels operating in the opposite direction. As a result, the channels operating in a direction towards the headend station follow the same path as the channels in a direction away from the headend station.

Further advantageous aspects of the invention are recited in further dependent claims.

The following publications are known to the applicants as relevant state of the art:
a. P. J. Urban et al., “First Design of Dynamically Reconfigurable Broadband Photonic Access Networks (BB Photonics)”, 2005 IEEE/LEOS Symposium Benelux Chapter Proceedings, Mons BE 2005, pp. 117-120;
b. D. Gutierrez et al., FTTH Standards, Developments, and Research Issues, Joint Conference on Information Sciences, JCIS, Salt Lake City, Utah, USA, pp. 1358-1361, July 2005.

On the level of both concept and implementation the present invention, however, comprises a large number of expansions, improvements and functions relative to the above references.

### BRIEF DESCRIPTION OF THE DRAWINGS

These and further elements, aspects and advantages of the invention will now be described in more detail with reference to preferred embodiments of the invention and, more particularly, with reference to the accompanying drawings and tables.

FIG. 1 a diagram of a flexible Passive Optical Network (FLEXPON);

FIG. 2 a variation of the configuration of FIG. 1;

FIG. 3 a second variation of the configuration of FIG. 1;

FIGS. 4a, 4b, 4c diagrams of a node with several connected users;

FIGS. 5a, 5b two possibilities for choosing the wavelengths;

FIG. 6 an advantageous embodiment of a node;

FIG. 7 a node with connected control signal; and

FIG. 8 a flow chart in accordance with the method.

### DETAILED DESCRIPTION OF PREFERRED EMBODIMENTS

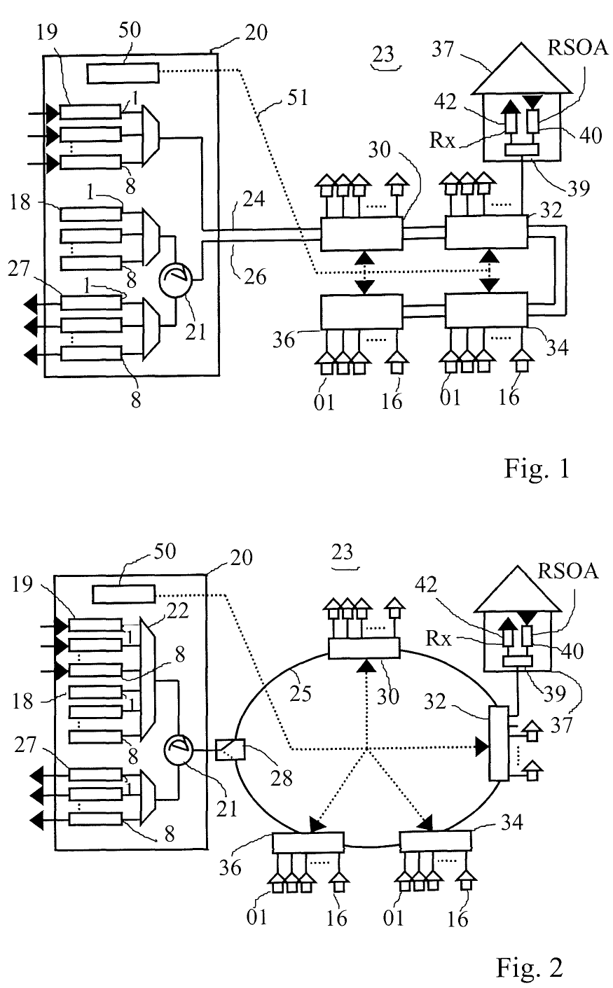

FIG. 1 shows by way of preferred embodiment a diagram of a flexible Passive Optical Network (PON) in accordance with the invention, which comprises on the left block 20 with a headend station and on the right a field 23 with the network per se and the end user stations. A number of frequency bands are produced in the headend station 20, for example in the blocks 19 eight wavelengths λ₁ to λ₈ each having a modulation bandwidth of 1.25 GHz, while the arrows suggest information sources not further indicated. These blocks 19 feed, as is shown, the forward fibre 24 of the external network 23 via a multiplexer. The wavelengths as such may be chosen at random but, as will be explained further in the text, they have to be sufficiently different from each other. The headend station itself can easily determine at what instant information will be transmitted to which one of the end users.

The receiving blocks 27 are fed by means of a demultiplexer by the return fibre 26. The arrows from blocks 27 indicate the outgoing information streams. In a simple embodiment the blocks 18 and the circulator 21 are omitted.

Four nodes 30 . . . 36 are shown by way of example, which nodes can serve each for example sixteen end user stations, which are connected to the two fibres 24/26 through said nodes and which are schematically shown here as dwellings of clients. The receiving blocks 27 are each for example suitable for a respective unique wavelength (range), while these wavelengths mutually differ sufficiently. Since two fibres 24/26 are provided, there is no interference between forward and return information streams. Various connection configurations of the end user stations will be described in further detail with reference to FIGS. 4a-4c, among them the use of only a single fibre for the two directions of transport.

The headend station further comprises a control module 50 for controlling the nodes via the dashed control lines 51, and, more particularly, for executing the assignment of wavelengths/channels to be described hereinafter. The realisation of this control line is not further specified for simplicity; it may be realised as dedicated lines, or as a common bus system. The control module 50 also knows the criteria germane to the assignment. The two physically separated fibre directions actually form two networks (forward/24 and return/26). Compared to a single fibre operating in two directions, flexibility is greater, but the cost price is naturally higher.

Sharing a single transmission channel from the headend station by a plurality of receiving end user stations is self-evident in the realisation described. If a plurality of end user stations share a single receiving channel, it may be advantageous to implement the following additional arrangement from FIG. 1. The blocks 18 and the circulator 26 form eight (as many as in the blocks 19) ‘blank’ channels, which are sent to the end users via the respective nodes. Each blank channel has an unmodulated carrier wave of its own, which carrier wave is modulated with the outgoing signal content from the end user stations and is reflected back to the headend station, and which carrier wave is routed via the circulator 21 to a dedicated receiving block 27 in the headend station. The necessary facilities in the nodes will be discussed at a later stage. Amplification may be effected as required. A module per se operating as a circulator can be realised with known components.

The facilities in a dwelling or end user station are indicated at 37. The receiving module Rx 42 receives the incoming data and is often operational for all wavelengths of the respective channels. Module RSOA 40 comprises a send mechanism in the absence of the blocks 18. Block 39 then forms a bidirectional relay element from/to the node. If, however, the modules 18 are present, block 40 will receive therefrom a blank or unmodulated wave; it is modulated with the return information, amplified where necessary, as a result of which the latter will reach the headend station. Block 39 separates the two received wavelengths (one from block 19 and one from block 18), and the whole forms a what is called colourless transceiver. The advantage of such a transceiver is that with which wavelength channels the end users are to be served need not be taken into account, and that only one type of transceiver needs to be produced and installed. In the preferred embodiment described here there is another important advantage: as a result of the use of a colourless transceiver, the assigned wavelength channels may be changed time and again without the transceiver needing retuning to ever changing wavelengths.

FIG. 2 illustrates a variation of the configuration of FIG. 1, in which forward and return signals are combined on a single fibre 25. The actual network 23 is connected to the circulator 21 via an optical switch 28. Therefore, one direction of circulation of the loop is intended to run towards the end user stations and the other direction of circulation is intended to run away from the end user stations. However, if for example the physical medium is interrupted, the remaining network can be reduced to that of FIG. 1, without the general functionality being decreased. In many cases the end user stations are relatively close together and relatively remote from the headend station. An interruption may occur more easily in such a long path to/from the headend station.

If no more than a single fibre is used for the forward and return signals, the blocks 19 together with the blocks 18 are collectively connected to the circulator 21. The connection to the network will be shown at a later stage. However, the wavelengths are to be selected more selectively now, because forward and return signals follow the same optical path and should not noticeably interfere with each other. This will be discussed at a later stage. Since the wavelengths of the forward signals (from blocks 19) and the wavelengths of the blanks (from blocks 18) are not the same by definition, they may be multiplexed in the headend station. Another embodiment is realised in that separate multiplexers are selected for this purpose.

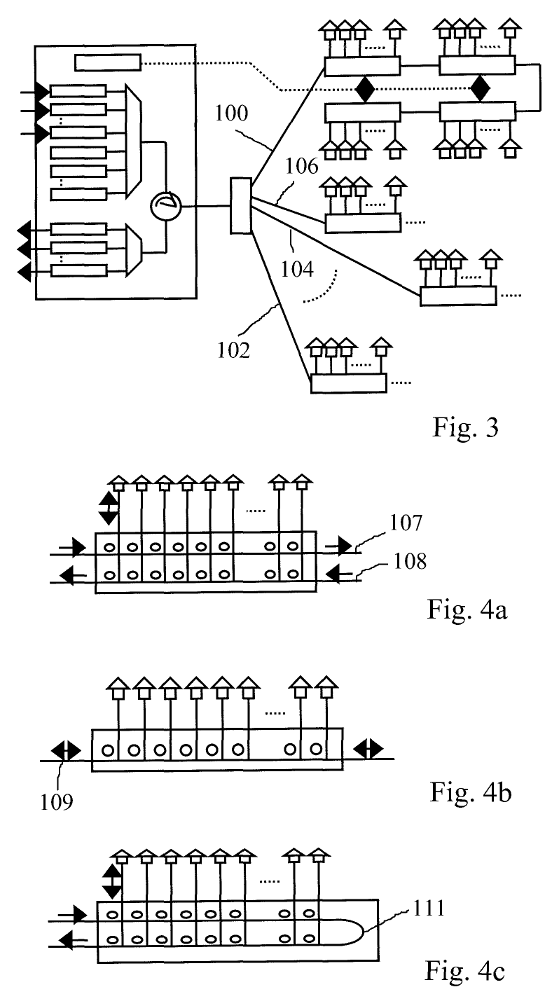

FIG. 3 illustrates a second variation of the configuration of FIG. 1. Here the physical network is distributed among various conductors. The subordinate network realised by the conductor 100 corresponds to that of FIG. 1. The subordinate networks 102-106 also realise such networks having each no more than one node (or also having various nodes). Needless to observe that with the examples of FIGS. 1, 2 and 3 all sorts of homogeneous and inhomogeneous networks can be realised with the forward and return signals being put on a single or on two separate fibres. Various dotted lines suggest different possibilities.

FIGS. 4a, 4b and 4c illustrate diagrams of a node with a plurality of connected end user stations. The circles stand for retunable filters, for example, microring resonators known per se, which ensure that the forward carrier waves are really switched to the end user stations and that the return carrier waves are switched to the headend station. The forward or return channel assigned to a user may be changed/switched by the retuning of the filter. By ensuring, during the retuning, that no more than a part of the channel is assigned to one end user, the channel concerned can be shared by a plurality of end users.

In FIG. 4a the forward and return signals are transported via separate fibres 107, 108 from and to the headend station and among the nodes. Forward and return channels are handled by separate filters, so that the forward and return wavelengths can be selected and switched practically independently of each other. If need be, it is also possible for each end user station to have separate fibres running to the node for the two directions of communication.

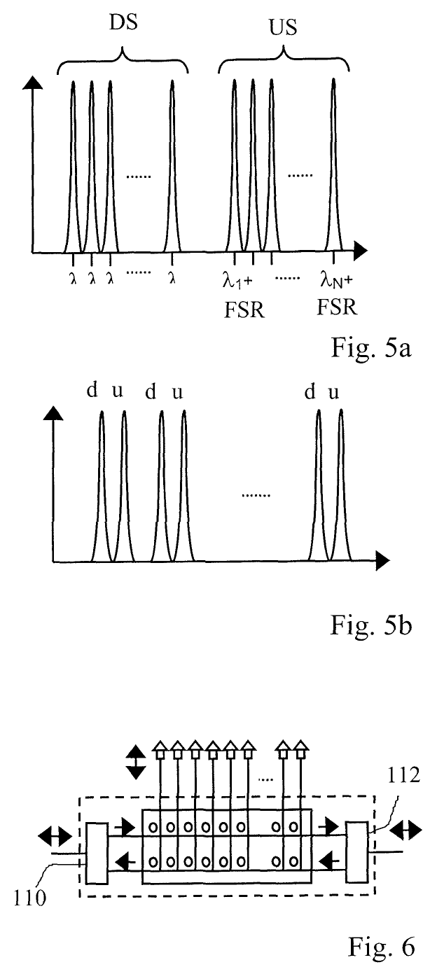

In FIG. 4b the forward and return signals are transported over one fibre 107. This requires a special choice between the frequencies, which will be explained with reference to FIGS. 5a and 5b. The circles here again stand for microring resonators. The node can be serially forwarded on the left and on the right hand side to a preceding/following node with dedicated end user stations.

FIG. 4c illustrates a third embodiment for a node. In accordance with the foregoing, the forward signals are distributed among the end users by the filters, for example, microring resonators again, in the upper branch. Blank channels are again used for the return signal, which blank channels are generated in the headend station and are sent into the system. Such a blank channel is then not selected by the filters in the upper branch, so that, ensuingly, they end up in the lower branch. The blank carrier waves are distributed among the right end users by the filters in the lower branch, where they are modulated at the end users'. The returning modulated channels find their way to the headend station along the same paths as the blank channels.

The advantage of the setup in accordance with FIG. 4c is that forward and return signals can be switched separately as shown in FIG. 4a, but that the communication with the headend station runs along a single fibre 111. This is also feasible in FIG. 4a, but this requires additional multiplexer elements (such as elements 110/112 in FIG. 6). These multiplexer elements lay restrictions on the choice of the wavelengths; the embodiment of FIG. 4c gives a practically independent choice of forward and return wavelengths, as long as the wavelength channels are not in each other's way.

FIGS. 4a and 4c have yet another important advantage. Normally speaking, in a system in which a plurality of end users share a single communication channel, it is essential that the right instants be determined at which each end user station is allowed to send information to the headend station. For, if two end users simultaneously send information, this will reach the headend station simultaneously and in a mixed version, so that it becomes illegible, which may lead to a serious ‘tailback’. So a protocol or handshake is required to indicate to each end user station when it is its turn to send. Such protocol is implemented in known PON systems.

FIGS. 4a and 4c offer the possibility of switching the return signals (going towards the headend station) independently of the forward signals. By momentarily opening up a return channel shared by one or more end users to no more than one end user, it is avoided that the transmissions of end users sharing a channel are mixed up. This may be effected by switching the filter elements in the nodes open and closed per end user for sending information, so that each user is allowed a period of time assigned by an assignment mechanism. The use of blank channels that can be modulated provides that control becomes even simpler: the moment the end user is allowed to transmit, the relevant filter of the node (30-36) is opened to that end user and the blank channel will reach this end user (and only this one). The end user station detects the presence of the blank channel and that is the sign for that station to be allowed to transmit. The end user station modulates the blank channel with its information to be transmitted; and the now modulated signal is reflected back to the headend station via the open node. As soon as the assignment mechanism regulated in the headend station (20) decides that the amount of transmit time for this end user is over, the relevant filter in the node is closed, so that the blank channel no longer reaches the end user. The end user station detects the absence of the blank channel and stops modulating. The blank channel is now available to a next end user. In this process the assignment mechanism can take account of the delays of the (light) signal. With this method an end user station no longer needs a communication protocol, further to be called protocolless point-to-multipoint communication for simplicity.

The forward channel shared by the same group of end users can, but need not, be left open all the time to the entire group of end users. For in the forward channel there is no chance of information being mixed up, because all information is generated in a single transmitter in the headend station. The assignment of more or less information (bandwidth) in the forward link to an end user is simply effected by addressing more or less information to this end user. Albeit all end user stations in the group will receive this information, as a result of the addressing, only that station will pass on the information to the end user the information is meant for.

A further major advantage of the protocolless point-to-multipoint method that has just been described is that at any moment the optical power is fully used for a single end user station. This solves a great problem in PON and other point-to-multipoint systems: there the power is usually distributed among the end user stations, as a consequence of which the available optical power works as a restriction to for example the number of end users.

FIGS. 5a, 5b illustrate two possibilities for selecting the wavelengths in the case of a single node. FIG. 5a illustrates a mode that implements the FSR principle (Free Spectral Range). The forward wavelength DS (from the headend station) are then always separated by an FSR from the dedicated return wave US. The joint forward waves and ditto for the joint return waves are situated in a range that is smaller than the FSR. The separation between successive channels is for example 50 GHz, whereas a 500 GHz difference is implemented between two groups of channels.

FIG. 5b illustrates an operating mode in which a pair of two wavelengths lying close together is used as one for forward (d) and one for return (u) signals, which both fit in well in the passband of a respective node. Should the occasion arise, the wavelength multiplexer of the end user stations is to be switched over when another wavelength will have to be used.

FIG. 6 illustrates an advantageous embodiment of a node. Forward and return signals are jointly multiplexed over the network here. However, now they are situated in two separate bands, which are combined by the left and right wavelength multiplexers 110, 112. Inside the actual node they are treated differently in the way shown with reference to FIG. 4a. So there are two rows of switching elements illustrated as rings. All this can, if so desired, be integrated on a single chip (dashed line). Needless to observe that the use of only a single fibre for the network per se causes a saving, not only on the actual material, but also on handling, protection etcetera.

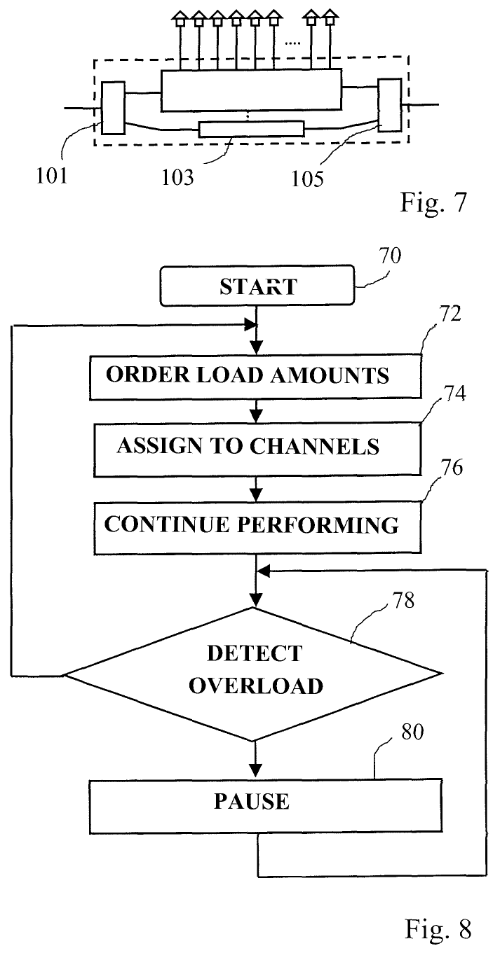

FIG. 7 illustrates a node, for example, implemented in accordance with FIGS. 4a, 4b or 4c, with connected control signal via the elements 101, 103 and 105. The control signal can be transmitted to the nodes in various ways. For example, a connection gate of the end user stations can be ‘sacrificed’ to be used as communication gate for the node. The figure, however, illustrates a different solution that cannot be used for the forward and return communication. Via (de)multiplexers 101 and 105, which operate frequency-specific outside the fibre, the control signal is rendered available in control module 103. Combinations with those of FIGS. 4a, 4b, 4c and 6 can obviously be implemented well by a person of skill in the art.

FIG. 8 illustrates a flow chart of the execution of the method. It is supposed that the system is initially working, which may also mean total absence of information traffic. In block 70, the hardware and software resources necessary for the control are reserved. In block 72, the amounts of load are arranged in declining order of magnitude. For simplicity, it is assumed that all channels have the same capacity and that all loads per station ‘fit’ into all channels. In block 74, the first load is assigned to the first channel. Then, in this same block 74, the second load is assigned to the first channel that still has sufficient space. This process is continued until all loads have been assigned. In order to obtain a stabler condition, a certain fraction per channel is not assigned, for example, several (dozen) percent.

Then, in block 76, the actual communication is performed. In block 78, there is detected whether there is an overload situation for a channel, whether such a situation is imminent, or whether there are other reasons to re-activate the assignment distribution. If there are, the system returns to block 72 and the assignment is executed once again. If, however, there is no such overload situation or the like, the control in block 80 pauses and the system then returns to block 78.

The illustrated diagram is naturally a simplified version. For example, no output has been provided. This may be realised, for example, in that in the loop of blocks 78/80 there is a separate detection available for detecting the absence of all communication. With non-uniform capacity channels such a flow chart can be set up in similar fashion.

Further it is possible for several limiting conditions mentioned earlier to be taken into consideration in block 74, so that other aspects of end station dynamics can be reckened with.

The table below shows relevant aspects of different networks

| | Point-to-Point | PON | FlexPON |
|---|---|---|---|
| Data rate per | 0.125 Gbit/s * | 1.25 Gbit/s | 1.25 Gbit/s |
| channel | | | |
| Number of channels | 1 | 1 | 1-8 |
| Number of end | 1 | 32 | 64 |
| users | | | |
| Average rate per | 0.125 Gbit/s | 0.039 Gbit/s | 0.0039-0.156 |
| end user | | | Gbit/s |
| Peak rate per end | 0.125 Gbit/s | 1.25 | 1.25 |
| user | | | |
| Statistical | No | Limited | extensive |
| multiplexing | | | |
| Scaling up of | Difficult | No | easy |
| capacity | | | |
| Scaling up of | Easy | Difficult | easy |
| number of end | | | |
| users | | | |
| Required optical | Low | high | (fairly) low |
| power budget | | | |
| Redundant | No | possible | possible |
| “feeder” | | | |
| Density of headend | Low | high | fairly high |
| station | | | |

The following parameters are important in this respect. The average rate per end user is the data rate if the bandwidth of the whole system is evenly distributed among the end user stations. The peak rate per end user is the data rate if the system bandwidth is assigned to its full extent to a single end user. In the case of the present realisation this is the maximum rate of a single channel, because every end user can be served by one channel at the most.

Bandwidth optimisation is the possibility to gear the bandwidth assignment to the need for it. Statistical multiplexing is the better utilisation of the capacity by distributing the total capacity over a larger group of users. In one-to-one, or worded differently, point-to-point communication networks there is no mention of bandwidth optimisation of statistical multiplexing. In these networks each end user station has its own individual connection. In the known PON system bandwidth optimisation is realised only partly: if the need increases for a specific user, whereas the others ask for less bandwidth, the former can have more bandwidth assigned to him. However, the statistical possibilities are limited. For example, if ten users desire a rate of 0.125 Gbit/s, then there is no bandwidth left for the other 22 user stations. In the realisation described, bandwidth optimization and statistical multiplexing can be applied in a much wider sense, because the general capacity of the system is 8×1.25 Gbits/s. Thus both within a 1.25 Gbits/s channel and in PON, optimization can be effected, but optimization can also be effected among the 8 channels. In the exemplary implementation this capacity is distributed over 64 in lieu of 32 end user stations, it is true, but even then the capacity is larger. Furthermore, the law of averages applies: since the number of user stations is larger, the group as a whole more often shows average behaviour. The system had better be designed then on the basis of supplying averages rather than dealing with peaks.

Scaling up the capacity is expanding the capacity of the network after it has been installed. In point-to-point communication this can solely be effected by providing individual users with a faster transceiver, for example 1.25 Gbits/s, and the adding of a comparable transceiver for the specific end users in the headend station. Installing such fast modules right from the start is very costly, because two such fast modules are necessary for each end user station. Scaling up in PON is difficult: because in that case all the end user stations are to have faster transceivers, even if the capacity were to be expanded in only a small number of them. In the set up in accordance with the invention it is only necessary to add a single channel for an expansion of the capacity. In the case where a number of end users have even larger rate desires, it is only necessary to install faster modules at these end users, combined with the addition of an accordingly faster channel in the headend station.

Scaling up the number of end user stations in point-to-point communication can simply be effected by adding a gate to the headend station and providing a new end user with a transceiver. An unused glass fibre does have to be available between the headend station and the new end user. In the PON system the number of end users is limited to a maximum. If a larger number of end users are active, a completely new network is to be implemented. According to the invention a start may be made with a small number of end users. By adding extra nodes ever more end users may be included in principle. In practice, the available optical power budget becomes a limiting factor at about 64 end users. The addition of a plurality of channels expands capacity. Furthermore, also the optical power budget improves, because the power is then distributed among fewer end users. This enables the number of end users to be increased if so desired. This especially holds for the cases of a protocolless point-to-multipoint communication, which in essence requires a significantly better power budget.

Required optical power budget: this is the difference between the power emitted by the headend station and the power received by the end user station, or the difference between the power emitted by the end user station and the power received in the headend station. In point-to-point communication the required power budget is small, because the headend transceiver is in direct contact with the transceiver of the end user station, without further splitters, nodes or other intermediate elements tapping this power.

In PON the required optical power budget is relatively high and thus critical, because the power is distributed among 32 end user stations and is thus reduced by a factor of 32 each time. The same goes for the return traffic.

According to the present invention the required optical power budget is relatively low. Albeit the power is distributed among many end users, the network is flexible: as more end users are included, channels are added. Of each channel considered on its own, the power is thus distributed among fewer end users. Furthermore, as mentioned earlier, the protocolless point-to-point communication has no distribution losses on the return traffic. This provides a significant improvement as regards required power and thus less hard-to-achieve specifications for components to be used. The forward traffic does not have this advantage, but as these signals are generated at a central position for a larger group of users, more powerful transmitters can easily be used here.

Redundant feeder: by means of an optical switch a redundant path can be created in the route to the nodes.

Headend station density: this denotes how many end users per rack or another such module in the headend station can be connected. In many cases a high spatial density also implies lower power consumption per connected user. This is important because a headend station is costly in terms of space and power consumption. Generally, Table 1 shows parameter values based on the state of the art. Within the scope of the invention various technological improvements can be introduced.

The invention has been described above with reference to preferred embodiments. Those skilled in the art will realise that a great many modifications and changes thereof may be introduced without leaving the scope of the appended claims. Therefore, such preferred embodiments are to be considered in an illustrative fashion rather than limiting fashion and no limitations other than those expressly stated in the appended claims may be inferred from them.

What is claimed is:

1. A method for use in a communication system comprising a headend station and a plurality of end user stations which are connected to the headend station by means of a physical medium, and a system of one or more channels realised on this medium, the method comprising:
providing an assignment mechanism for assigning a relevant channel to an end user station in a manner whereby no more than a single channel is assigned to an end user station and each channel is assigned to a subset of zero, one or a plurality of end user stations; and
under the control of the detection of at least one of channel overload and end user dynamics, activating said assignment mechanism to realise a new assignment of a plurality of channels while the condition is maintained that no more than a single channel is or remains assigned to each end user station.

2. A communication system comprising:
a headend station and a plurality of end user stations connected to the headend station by means of a physical medium;
a system of one or more channels realised on said medium;
an assignment mechanism for assigning a relevant channel to an end user station in a manner whereby no more than a single channel is assigned to an end user station and each channel is assigned to a subset of zero, one or a plurality of end user stations; and
means, operating under the control of the detection of at least one of channel overload and end user dynamics, for activating said assignment mechanism to realise a new assignment of a plurality of channels while the condition is maintained that no more than a single channel is or remains assigned to each one of the end user stations.

3. A communication system as claimed in claim 2, characterized in that two separate physical media are provided for the forward communication from the headend station and for return communication to said headend station.

4. A communication system as claimed in claim 2, characterized in that a shared physical medium is provided for both forward communication from the headend station and return communication towards the headend station.

5. A communication system as claimed in claim 2, in which said headend station comprises a transmitter substation and a receiver substation which are connected to said physical medium by means of a circulator to thereby maintain a two-way traffic with the end user stations.

6. A communication system as claimed in claim 2, in which said headend station is connected to said physical medium by means of a three-way switch, the medium being arranged as a loop so as to create a reversible direction of transport in said loop.

7. A communication system as claimed in claim 2, in which said physical medium comprises one or more nodes, in which at least one node is connected in parallel to a plurality of end user stations and each end user station is connected to a single node.

8. A communication system as claimed in claim 7, in which said nodes are arranged to have at least one tunable filter for each connected end user.

9. A communication system as claimed in claim 2, in which said channels in a direction towards said headend station are modulated on respective carrier waves supplied by the headend station.

10. A communication system as claimed in claim 9, in which all channels operating in a first direction are remote by an integer number times the free spectral range associated with the retunable filters from all the channels that are operating in the opposite direction.

11. A communication system as claimed in claim 9, in which for each end user station pairs of forward and return carrier waves are relatively closer together and further away from other pairs of carrier waves assigned to other end user stations.

12. A communication system as claimed in claim 2, in which an end user station comprises a colourless transceiver to enable the receiving of an assigned channel as well as the transmission of return information on another channel assigned by the headend station.

13. A communication system as claimed in claim 2, further comprising one or more main nodes to which respective subordinate nodes are connected.

14. A communication system as claimed in claim 10, which is arranged in a non-homogeneous configuration.

15. A communication system as claimed in claim 2, in which forward and return channels are arranged in two separate wavelength ranges.

16. A communication system as claimed in claim 2, in which each channel at any one moment is assigned to only a single end user and, by means of switching of said channel to a next user, the capacity of the network is distributed among the end users.

17. A communication system as claimed in claim 9, in which a modulated carrier wave supplied by the headend station can be assigned to only a single end user station at any one moment, which relevant end user station detects the presence of said carrier wave and has thus obtained the possibility of modulating the carrier wave.

18. A communication system as claimed in claim 16, in which the channel assignment to an end user station is effected by switching filter elements in a node to which the end user station is connected.

19. A communication system as claimed in claim 17, in which the channel assignment to an end user station is effected by switching filter elements in a node to which the end user station is connected.
